(19) United States
(12) Patent Application Publication
(10) Pub. No.: US 2014/0250022 A1
(43) Pub. Date: Sep. 4, 2014

(54) FOLLOWING-UP CONTROLLING METHOD OF INDUSTRIAL PRODUCTS USING PORTABLE COMMUNICATION DEVICE

(71) Applicants: Jae In Lee, Gyeonggi-do (KR); Jae Hak Lee, Gyeonhggi-do (KR); Sung Woo Park, Seoul (KR)

(72) Inventors: Jae In Lee, Gyeonggi-do (KR); Jae Hak Lee, Gyeonhggi-do (KR); Sung Woo Park, Seoul (KR)

(73) Assignees: MINDWARECORPS CO., LTD., Seoul (KR); MINDWAREWORKS CO., LTD., Seoul (KR)

(21) Appl. No.: 13/822,398

(22) PCT Filed: Aug. 31, 2011
(86) PCT No.: PCT/KR2011/006437

§ 371 Date: Jan. 23, 2014

(30) Foreign Application Priority Data
Sep. 13, 2010 (KR) 10-2010-0089246

(51) Int. Cl. G06Q 30/00

(52) U.S. Cl. CPC G06Q 30/0185; G06Q 30/018
USPC 705/318; 705/317

(57) ABSTRACT

The present invention relates to a follow-up control method of a product online, and more particularly, to a method of registering a product to a management server after capturing the barcode of the product by using a portable device and performing a follow-up control of the product online by using the registered barcode. A follow-up control method of a product by using a portable device includes: identifying a product by capturing the barcode of the product with a portable device through a program built in the portable device or identifying a product by directly inputting product information into the portable device; registering the product by transmitting data regarding the identified product information to a management server; and performing a follow-up control on the product online by a user after the product registration is completed.

### TECHNICAL FIELD

The present invention relates to the follow-up management method for a product on-line and, more particularly, to a method of photographing the barcode of a product by using a portable device, registering the product with a management server, and performing the follow-up of the registered product on-line.

### BACKGROUND ART

With the recent development of the Internet and portable device technology, a variety of techniques, such as a technique related to after services of numerous manufactured products, a technique for the purchase and management of a product, a lost article management technique when a product is lost after the product was purchased, and an authentic authentication check technique of a product through the code or serial number of the product, are being developed and supplied.

As these techniques, LOST PROPERTY HANDLING METHOD USING TAG (Patent Registration No. 10-0364144), A SYSTEM FOR FINDING AND RETURNING THE OWNER OF THE LOST ITEM BY MINIMIZING LEAKAGE PERSONAL INFORMATION (Patent Laid-Open Publication No. 10-2009-0116681), MANAGEMENT METHOD OF ARTICLE (Patent Registration No. 10-0892882), APPARATUS AND METHOD FOR GENERATING A PIN CODE FOR PURCHASE AUTHENTICATING (Patent Registration No. 10-0889038), SYSTEM AND METHOD FOR PRODUCT HISTORY MANAGEMENT USING SERIAL NUMBER (Patent Registration No. 10-0844177), and METHOD FOR CONFIRMING GOODS BY USING UNIQUE IDENTIFICATION CODE (Patent Laid-Open Publication No. 10-2004-0052278) have been laid-open or registered in Korean Intellectual Property Office (KIPO).

Patent Registration No. 10-0364144 has a problem in that a method of processing a lost article without an identification tag cannot be implemented because it includes a basic premise that an identification tag (i.e., a tag to which a unique number is assigned) must be assigned to a target.

Patent Laid-Open Publication No. 10-2009-0116681 relates to a system for issuing an identification tag for a product over wired/wireless Internet and returning the lost product to the original owner if the identification tag of the product is reported by an acquisitor when the product was lost. The identification tag of this technique, however, is limited to a lost article, and a range in which a product is recognized based on the tag is too limited.

Patent Registration No. 10-0892882 provides an article management method capable of minimizing the exposure of personal information by matching an article code unique to an article with only a terminal code unique to the terminal of an article owner and registering the article code and the terminal code in order to fundamentally prevent the drain of very sensitive personal information, such as a name, an address, and a resident registration number, and damage accordingly. However, this patent discloses only that an article code unique to an article must be matched with a terminal code and registered in a method of registering an article, but does not disclose a method of registering a variety of articles.

Patent Registration No. 10-0889038 discloses a unique identification code generation apparatus and method for purchase authentication capable of automatically processing procedures, such as the generation, issue, error check, and analysis of a commodity identification code, based on a web. This patent is technology for generating and verifying an identification code in relation to only a purchased product so that a purchase authentication portion performed off-line is possible on-line. This patent is very limited in that a commodity identification code is used only as a specific code for purchase authentication.

Patent Registration No. 10-0844177 relates to a product history management system and method using a serial number, and this patent is technology that is limited to and applied to a product having a serial number.

Patent Laid-Open Publication No. 10-2004-0052278 relates to a commodity confirmation method using a unique recognition code. In this patent, whether an order commodity is authentic or not is checked through the issue and verification of a unique recognition code. The unique recognition code itself is limited to and applied to the generation and verification of a code that can be applied as one business method.

When viewing the aforementioned techniques comprehensively, an on-line article management method or business models implemented through the generation and verification steps of a code, a tag, or a serial number are being developed, supplied, and used. However, an integrated and general product registration method and system capable of managing the lift cycles of all products, including a purchase, A/S, a lost, the authentication of an honest commodity, the exchange of parts, or the transaction of used goods, irrespective of whether a target article (an article, a commodity, or a product) includes a code or not, whether the code has been damaged or not, and whether an individual product identification instance is present or not in the same product group have not yet been developed.

### PRIOR ART DOCUMENTS

### Patent Documents

(Patent Document 1) 1. Korean Patent Registration No. (B1) 10-0364144 (2002 Dec. 16)
(Patent Document 2) 2. Korean Patent Laid-Open Publication No. (A) 10-2009-0116681 (2009 Nov. 11)
(Patent Document 3) 3. Korean Patent Registration No. (B1) 10-0892882 (2009 Apr. 15)
(Patent Document 4) 4. Korean Patent Registration No. (B1) 10-0889038 (2009 Mar. 17)
(Patent Document 5) 5. Korean Patent Registration No. (B1) 10-0844177 (2008 Jun. 30)
(Patent Document 6) 6. Korean Patent Laid-Open Publication No. (A) 10-2004-0052278 (2004 Jun. 23)

### DISCLOSURE

### Technical Problem

The present invention has been made to solve the above problems, and an object of the present invention is to provide an integrated and general follow-up management method of a product capable of managing the lift cycles of all products irrespective of whether a target article includes a code or not, whether the code has been damaged or not, and whether an individual product identification instance is present or not, in the same product group.

### Technical Solution

To achieve the above object, a follow-up management method for a product using a portable device in accordance with the present invention may include a product recognition step of photographing the barcode of the product by using a program embedded in the portable device by using the portable device and recognizing the product based on the photographed barcode or directly inputting information about the product to the portable device and recognizing the product based on the inputted information; a product registration step of sending the information of the product recognized in the product recognition step to a management server and registering the product; and a product follow-up management step of performing the follow-up management of the product on-line by the user of the portable device after the product registration step.

Here, the product recognition step and the product registration step preferably are classified into cases where the individual instance of the barcode is included or not included, the product is a product databased and registered with the server or a product not databased and registered with the management server, and the barcode is identifiable or not identifiable and then processed.

Here, the product recognition step and the product registration step may include a code value transmission step in which the barcode of the product is photographed by the portable device and a code value of the barcode is sent to the server; a code value identification step in which the server determines whether the received code value of the barcode is identifiable or not and performs a next step based on a result of the determination; an individual instance identification step in which the portable device performs step-by-step registration and direct input registration if the code value is determined to be not identifiable in the code value identification step and the server determines whether an individual instance of the product is identifiable or not if the code value is identifiable; and a serial number generation step in which the portable device executes the product registration if the instance is determined to be identifiable in the individual instance identification step and the server itself generates a serial number or the server requests the manufacturing company of the product to generate a serial number if the instance is not identifiable.

Here, the step-by-step registration and the direct input registration may be a step of sequentially performing the registration of the product by sequentially classifying pieces of information related to the product into higher-level information to lower-level information and presenting the pieces of information.

Here, the server or the manufacturing company preferably generates a two-dimensional code for the corresponding product based on information received according to the step-by-step registration and the direct input registration and sends the two-dimensional code to an owner of the portable device so that the owner can check the two-dimensional code.

Here, the individual instance may be interpreted as meaning an individual value for one individual product included in a plurality of product groups having an identical model.

Here, the follow-up management method may further include a two-dimensional barcode generation step in which the server automatically generates a two-dimensional barcode for the product based on the serial number and allows the owner of the portable device to check the two-dimensional barcode, after the serial number generation step.

Here, the follow-up management method may further include a step in which the owner of the portable device sends corresponding information to the server and receives information about whether the product is genuine or not from the server in order to check forgery or robbery for the product.

Here, the follow-up management method may further include a step in which the owner of the portable device sends corresponding information to the server and receives information about whether the product is genuine or not from the server in order to check forgery or robbery for the product.

Here, the follow-up management of the product follow-up management step may include one or more of point management of the product in which a point as much as an amount settled in response to a purchase and processing of the product is increased or decreased and recorded, used goods transaction management of the product in which an on-line used goods transaction of the product is executed, disuse management of the product in which a disuse of the product is requested and checked, A/S management of the product in which A/S for the product is requested and checked, contribution and donation management of the product in which a contribution or donation of the product is requested and checked, and lost article management in which a lost product is checked and returned when the product is lost.

Here, in at any time before or after the product recognition step and the product registration step or before or after the product follow-up management step, a purchase history evidence document processed when the product is purchased may be photographed by the portable device and stored.

### Advantageous Effects

In accordance with the technical solution of the present invention, an integrated and general follow-up management method of a product is provided so that the lift cycles (a purchase, A/S, a lost, the authentication of an honest commodity, the exchange of parts, or the transaction of used goods) of all products can be managed irrespective of whether a target article includes a code or not, whether the code has been damaged or not, and whether an individual product identification instance is present or not, in the same product group.

### DESCRIPTION OF DRAWINGS

FIG. 1 is a flowchart of a follow-up management method for a product using a portable device in accordance with the present invention.

FIG. 2 shows a pattern format appearing in a first recognition step of a product shown in FIG. 1.

FIG. 3 shows a pattern format appearing in a product registration step shown in FIG. 1.

FIG. 4 shows a pattern format appearing in a product management step shown in FIG. 1.

FIG. 5 shows a detailed flow of the first recognition step of the product shown in FIG. 2.

FIGS. 6 to 10 show detailed examples of a pattern-by-pattern registration flow appearing in the first recognition step of the product.

FIG. 11 shows the display screen of a portable device for executing the follow-up management method for a product using a portable device in accordance with the present invention.

FIG. 12 shows a detailed example of a used goods transaction process of a product registered in the follow-up management method for the product using a portable device in accordance with the present invention.

FIG. 13 shows a detailed example of a process of processing a point balance that is generated according to the management of the product registered in the follow-up management method for the product using a portable device in accordance with the present invention.

FIG. 14 shows a detailed example of a contribution or donation process for the product registered in the follow-up management method for the product using a portable device in accordance with the present invention.

FIG. 15 shows a detailed example of a Buy Care process for the product registered in the follow-up management method for the product using a portable device in accordance with the present invention.

FIG. 16 shows a detailed example of a receipt registration process for the product registered in the follow-up management method for the product using a portable device in accordance with the present invention.

FIG. 17 shows a detailed example of a loss notification and check process when the product registered in the follow-up management method for the product using a portable device in accordance with the present invention is lost.

### MODE FOR INVENTION

A follow-up management method for the product using a portable device in accordance with the present invention and acting effects thereof are described below with reference to the accompanying drawings.

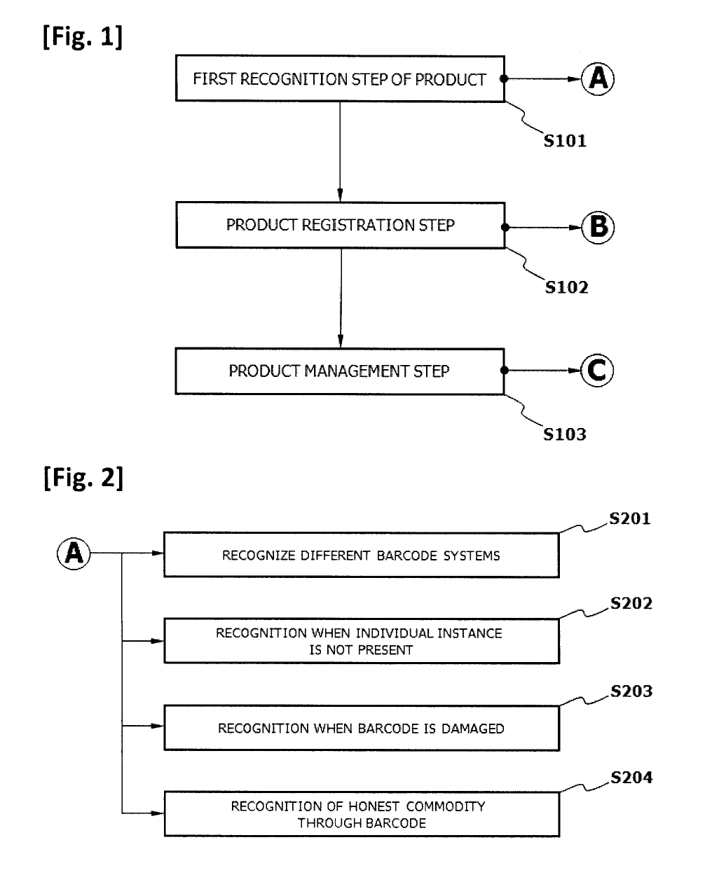

FIG. 1 is a flowchart of a follow-up management method for the product using a portable device in accordance with the present invention.

A product disclosed in the present invention includes industrial products including home appliances as its major target. In general, the product includes a variety of barcodes, for example, a variety of barcode systems, such as CODE128 and CODE 39, in addition to UPC of U.S.A., EAN of Europe, and KAN of Korea, that is, one-dimensional barcodes.

In a process of developing a platform capable of managing the entire lift cycle, including photographing a variety of the barcodes by using a portable device, registering the photographed barcodes, managing corresponding products, and performing the follow-up management, A/S, and disuse of the products, through a portable device, there are proposed the first recognition technology capable of registering and recognizing the products and the follow-up management method of the registered products.

As shown in FIG. 1, a purchased product or an owned product first experiences a first recognition step S101 of the product. In the first recognition step S101 of the product, a barcode printed on the product can be photographed or information about the product can be directly inputted. The inputted barcode value or information of the product is transmitted to a management server.

If the corresponding product can be identified and the product is recognized by corresponding software in the first recognition step S101 of the product, the product experience a product registration step S102. In the product registration step S102, the recognized product is registered with the management server, and the registered product is subject to on-line follow-up management from when the product is registered to when the product is disused in association with the servers of various associated sites.

If the product is registered with the management server through the product registration step S102, the product is managed on-line. That is, in the product management step S103, the comprehensive follow-up management of the product, such as the use, A/S, and used goods transaction of the product, the check of a lost article, whether the product is an honest commodity or not, the disuse, contribution, and donation of the product, and control of a point balance of a profit or commission occurring in use, is performed on-line in association with related sites.

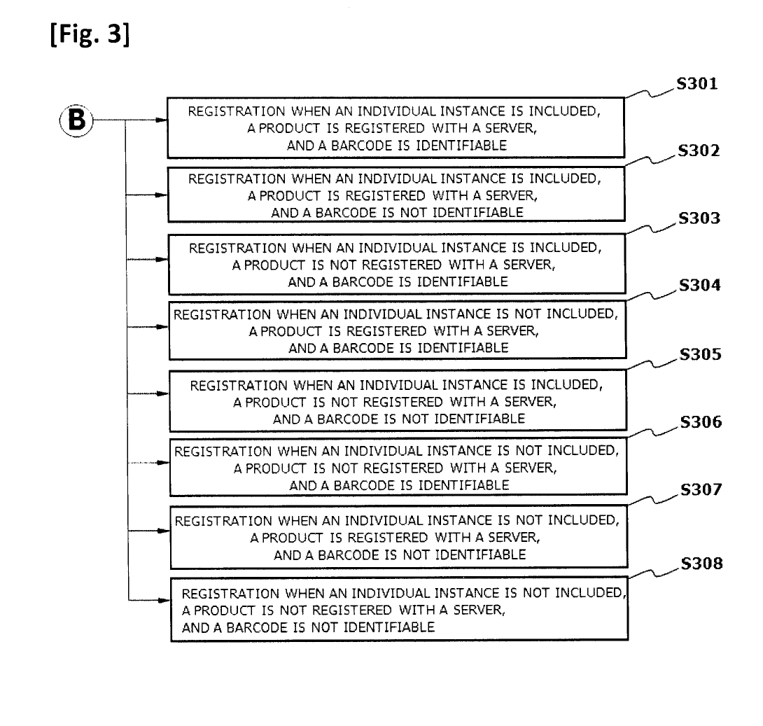

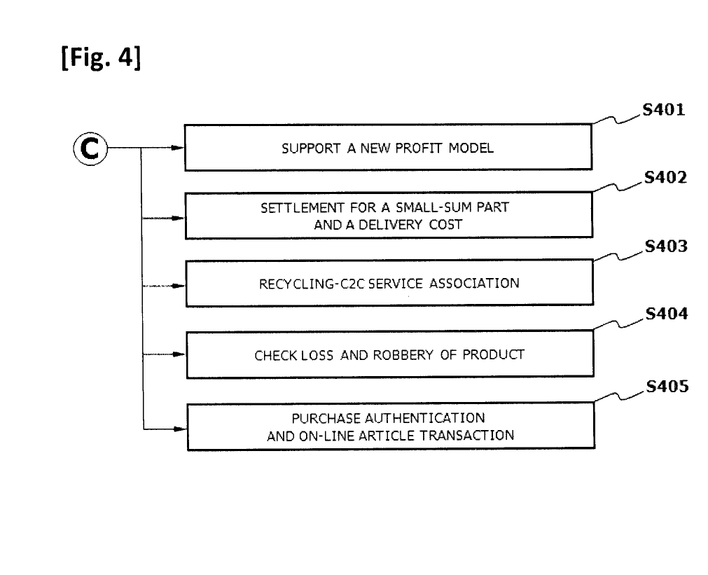

FIG. 2 shows a pattern format appearing in the first recognition step of the product shown in FIG. 1, FIG. 3 shows a pattern format appearing in the product registration step shown in FIG. 1, and FIG. 4 shows a pattern format appearing in the product management step shown in FIG. 1.

A format that may occur in the first recognition step S101 of the product shown in FIG. 1 may be assumed as in FIG. 2.

A variety of barcodes can be printed on the product. The barcode is analyzed by a reader, and the barcode value can be transmitted and used on-line. In this case, the recognition of the product is particularly not problematic at step S201.

There is no problem in recognizing the barcode value of the barcode, but the recognition of the product when information about an individual instance is not present has to be solved at step S202.

Here, the individual instance means an individual value of the product and means a value that specifies one individual product in a product group having the same model. That is, if a manufacturing company called Samsung Electronics has manufactured two hundred thousands of refrigerators having a model A, individual instances mean unique values to identify the refrigerator products from 1 to 200,000 along with the model information A.

Furthermore, the recognition problem of the product when a barcode is present, but the barcode has been damaged or when a barcode itself is not present has to be solved at step S203.

In addition, only when the product is an honest commodity by checking whether the corresponding product is an honest commodity through the barcode, the product has to be registered at step S204.

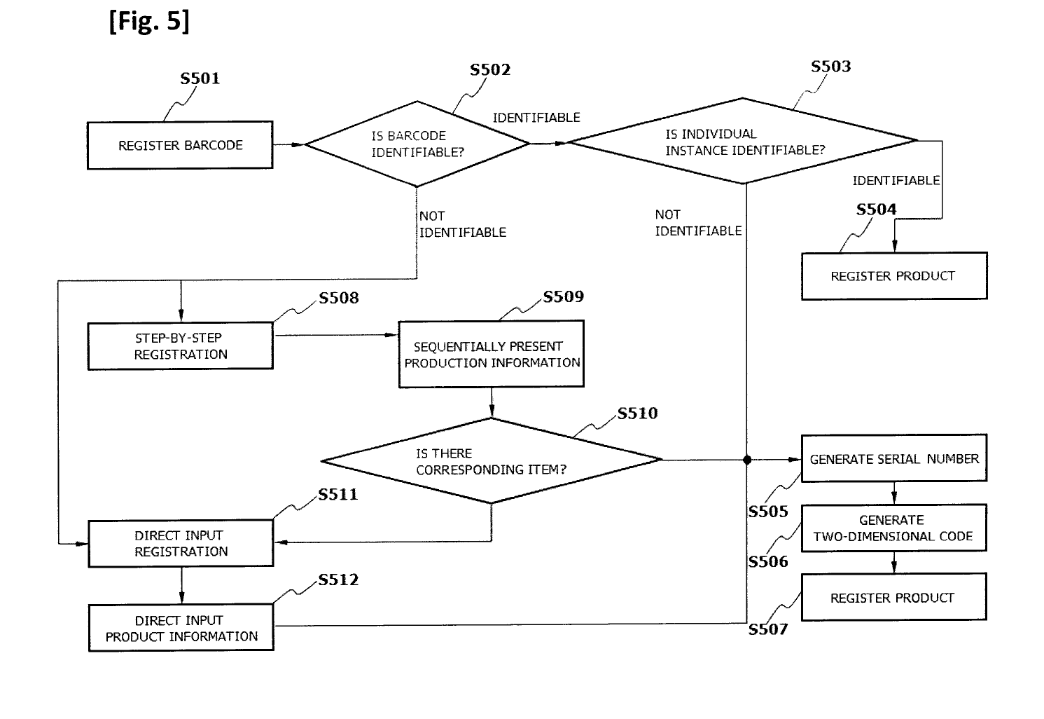

The objects of the steps S201 to S204 will be described in detail with reference to FIGS. 5 and 6 to 10.

The product registration step S102 shown in FIG. 1 can be performed in accordance with a method, such as that shown in FIG. 3.

If the recognition problem of the corresponding product is solved, the product registration problem will become a starting point of product follow-up management on-line.

In the present invention, processing is performed by assuming that the product registration method includes 8 types as shown in FIG. 3. This method does not limit the present invention, but a preferred configuration method for a detailed embodiment is described as an example.

A basis premise includes 3 types. The product registration method may vary depending on whether the corresponding product includes individual instance information or not, whether the corresponding product is a product databased in the management server or not, and whether the barcode can be identified or not.

A step S301 corresponds to a case where the individual instance is included, the corresponding product is a product databased in the management server, and the barcode can be identified. In this case, the corresponding product can be automatically registered with the management server with no problem.

A step S302 corresponds to a case where the individual instance is included, the corresponding product is a product databased in the management server, and the barcode cannot be identified, and a method thereof will be described later. In this case, after requesting manual registration and inputting information about the product, the corresponding product is registered with the management server.

A step S303 corresponds to a case where the individual instance is included, the corresponding product is a product not databased in the management server, and the barcode can be identified. In this case, after requesting the manufacturing company of the corresponding product to database the corresponding product with the management server, the corresponding product can be registered, but the corresponding product can be listed only in the case of a famous company.

A step S304 corresponds to a case where the individual instance is not included, the corresponding product is a product databased in the management server, and the barcode can be identified. In this case, after registering the corresponding product with the management server, an individual instance for the product is generated and transmitted to a portable device user.

A step S305 corresponds to a case where the individual instance is included, the corresponding product is a product not databased in the management server, and the barcode cannot be identified. In this case, after requesting manual registration for the product and requesting the manufacturing company of the product to database the product, the corresponding product is registered with the management server.

A step S306 corresponds to a case where the individual instance is not included, the corresponding product is a product not databased in the management server, and the barcode can be identified. In this case, after automatically generating the individual instance and requesting a corresponding manufacturing company to database the corresponding product, the product can be registered with the management server.

A step S307 corresponds to a case where the individual instance is not included, the corresponding product is a product databased in the management server, and the barcode cannot be identified. In this case, the product can be registered by requesting manual registration and automatically generating the individual instance.

A step S308 corresponds to a case where the individual instance is not included, the corresponding product is a product not databased in the management server, and the barcode cannot be identified. After requesting manual registration and requesting a manufacturing company to database the product, the individual instance is automatically generated and the product is registered with the management server.

The product management step S103 shown in FIG. 1 can be deployed in various ways in types shown in FIG. 4.

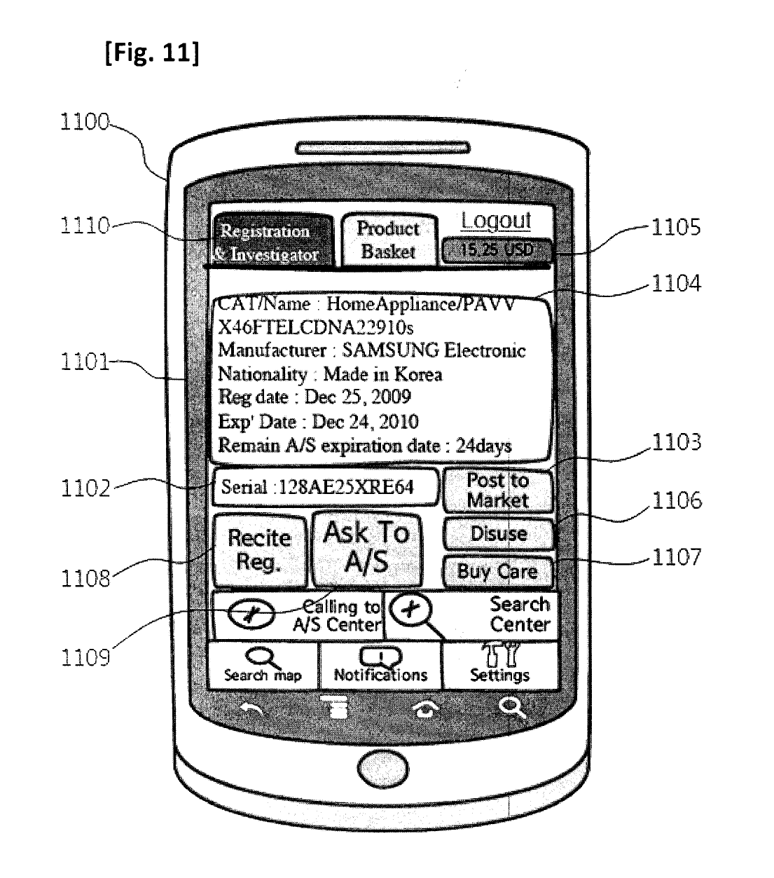

The types of the product management step S103 can include creating a new profit model in real life use (S401), adjusting settlement for a small-sum part and a delivery cost and a point balance thereof (S402), selling a used product associated with a recycling site (S403), contribution and donation through associated sites (S403), checking and recovering a product through associated sites when the product is lost and robbed (S404), and purchase authentication and on-line article transaction (S405). Furthermore, in the case of a product requiring the periodic exchange of parts, the exchange service of parts can be performed on-line. This follow-up management type can be various, and representative and detailed examples thereof will be described later with reference to FIGS. 11 to 17.

FIG. 5 shows a detailed flow of the first recognition step of the product shown in FIG. 2.

The identification of the product generated in the product registration and recognition processes can be classified into the automatic registration of the corresponding product after identifying the barcode of the product, registration when the product code can be identified, but individual instance information is not present, and registration when a product code has been damaged or it is difficult to check the product code.

Furthermore, it is necessary to check whether the product is an honest commodity or not the honest commodity needs to be checked in the product registration process. If a portable device is changed, the continuity of product registration may be taken into consideration.

As shown in FIG. 5, in the product registration and recognition method in accordance with the present invention, first, the user of a portable device selects a barcode registration step S501, a step-by-step registration step S508, and a direct input registration step S511.

If the owner of the portable device selects the barcode registration step S501, a command is issued so that a barcode printed on the product is photographed and the photographed barcode is transmitted to the server.

The server verifies the identifiability of the received barcode at step S502. If the identifiability of the barcode is not present, the server issues a command so that a registration procedure is performed through the step-by-step registration step S508 or the direct input registration step S511.

If the identifiability of the barcode is present, the process proceeds to a step S503 of verifying the identifiability of an individual instance.

If the identifiability of the individual instance is present, the registration of the product is automatically completed at step S504.

If the identifiability of the individual instance is not present, the server generates a serial number or requests a manufacturing company to generate a serial number and receives the generated serial number at step S505.

The server can generate a kind of virtual serial number and provides the generated virtual serial number for the follow-up management of the product. The server inserts an identification code unique to the product into a barcode only including a manufacturing country/manufacturing company/product standard classification/product code information about the purchased product so that the barcode including the identification code can be used as information for the lift cycle of the product, such as the future A/S, used goods transaction, and disuse.

The server automatically generates a two-dimensional barcode including the unique number of the product based on the generated serial number and sends the generated two-dimensional barcode to the owner of the portable device so that the owner checks the generated barcode at step S506. Here, an image of the two-dimensional barcode transmitted to the portable device is not stored in the portable device, but can be stored only in the server.

After the owner checks the two-dimensional barcode, the product is registered with and managed by the server at step S507.

Next, if the owner of the portable device selects the step-by-step registration step S508 in the product registration method or it is determined that the identifiability of the barcode is not present at step S102 in the barcode registration step S501, the step-by-step registration step S508 is selected.

Next, the server sequentially displays pieces of information about the product from higher-level information to lower-level information so that the corresponding product has identifiability and the owner of the portable device can select the pieces of information about the product at step S509.

The pieces of information about the product are sequentially provided from higher-level information, such as a manufacturing country/manufacturing company/type of the product (for example, Korea/Samsung Electronics/home appliances/TV), to lower-level information and can be inputted step by step.

Here, if there is no information related to the corresponding product, the direct input registration step S511 is requested at step S509. After the pieces of information from higher-level information to lower-level information about the corresponding product are sequentially selected, the server generates a serial number for the corresponding product at step S505, automatically generates a two-dimensional barcode for the product based on the serial number at step S506, and completes the product registration at step S507.

Next, if the owner of the portable device selects the direct input registration step S511 in the product registration method or it is determined that the identifiability of the barcode is not present at step S502 or the product information is not related at step S509, the direct input registration step S511 is selected and the owner of the portable device directly inputs information about the product. Likewise, the server generates a serial number for the product at step S505, generates a two-dimensional barcode for the product based on the generated serial number at step S506, and completes the registration of the product at step S507.

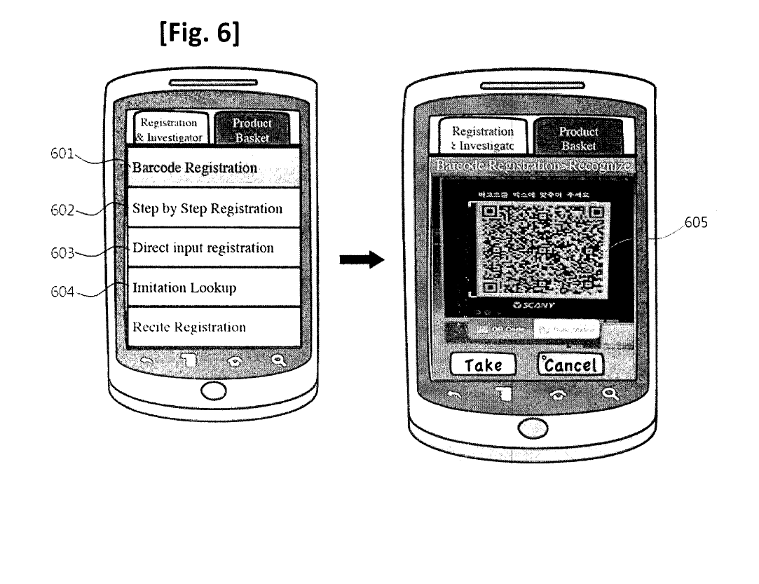

FIGS. 6 to 10 show detailed embodiments in which the method of registering or recognizing a product has been implemented in a platform that enables the follow-up management of the product by using a portable device in accordance with the present invention.

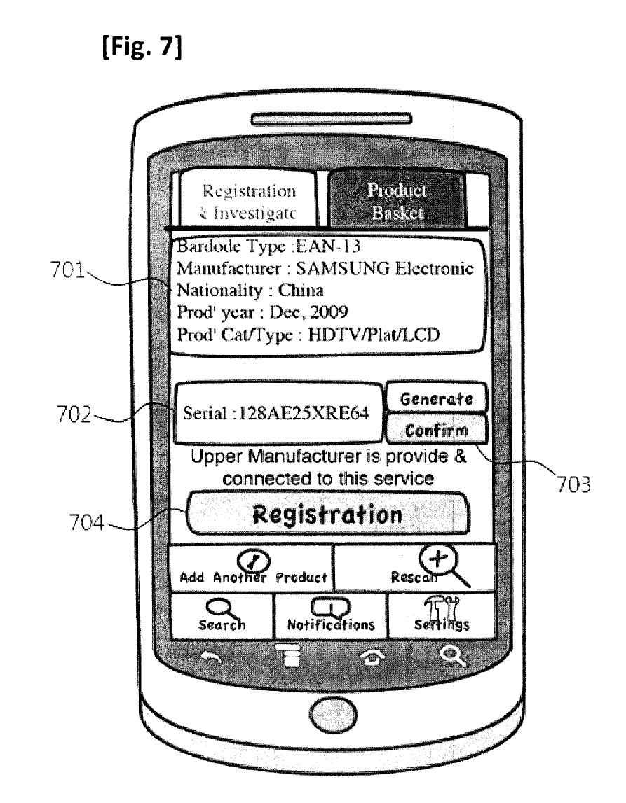

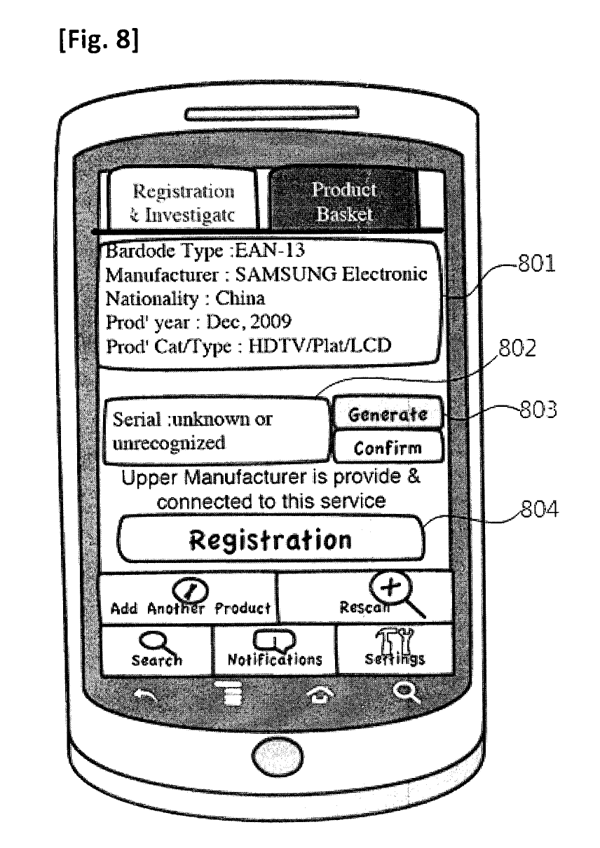

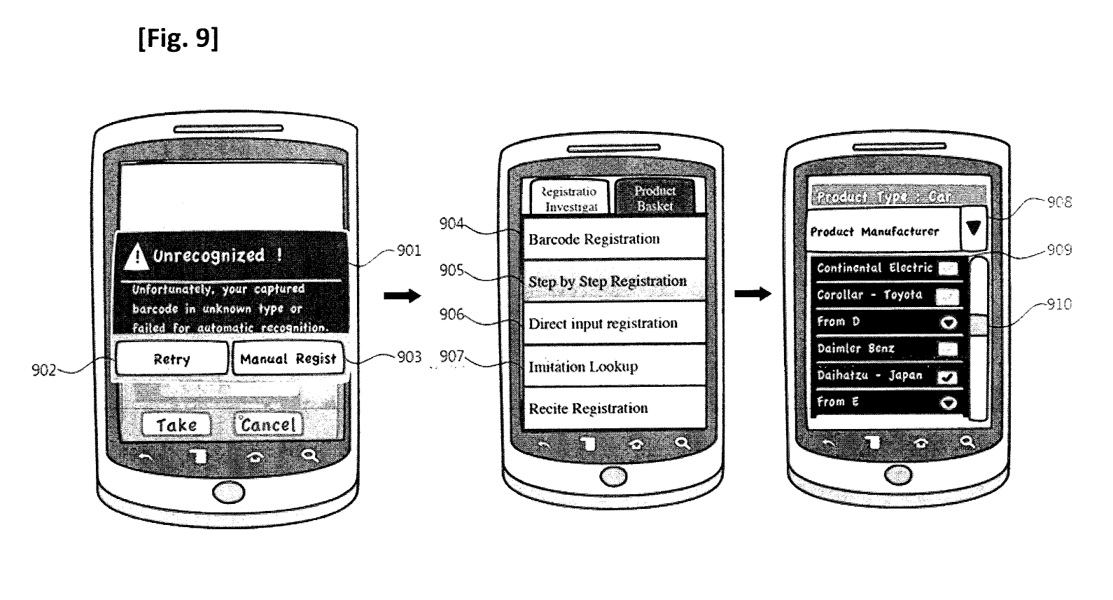

The figures of FIGS. 6 and 7 illustrate an example of a product registration implementation when the identifiability of a product code is present and the identifiability of an individual instance is present. The figures of FIGS. 6 and 8 illustrate an example of a product registration implementation when the identifiability of the product code is present, but the identifiability of an individual instance is not present. The figures of FIGS. 6 and 9 illustrate an example of a product registration implementation when both the identifiability of a product code and the identifiability of an individual instance are not present.

First, a case where the identifiability of a product code is present and the identifiability of an individual instance is present is described below.

Referring to FIG. 6, if an icon for executing product registration is present in the portable device and the icon is executed, a barcode registration region 601, a step-by-step registration region 602, a direct input registration region 603, and an imitation lookup region 604 are displayed in the portable device.

Here, when the barcode registration region 601 is selected, the barcode is photographed in response to a command to instruct the photographing of the barcode 605 and a code value for the corresponding barcode is transmitted to the server at the same time or sequentially.

Referring to FIG. 7, if the identifiability of the barcode is present and the identifiability of the individual instance is present, a code value display part 701 in which a barcode type, a manufacturing company, a manufacturing country, a manufacturing date, and a product type are displayed, a serial number display part 702 in which the serial number of the product is displayed, a serial number generation icon 703, and a registration icon 704 can be displayed as in FIG. 7, and product registration is automatically performed.

A case where the identifiability of the product code is present, but the identifiability of an individual instance is not present is described below.

Referring to FIG. 6, if an icon for executing product registration is present in the portable device and the icon is executed, the barcode registration region 601, the step-by-step registration region 602, the direct input registration region 603, and the imitation lookup region 604 are displayed.

Here, when the barcode registration region 601 is selected, the barcode of the product is photographed in response to a command to instruct the photographing of the barcode 605 and a code value for the corresponding barcode is transmitted to the server at the same time or sequentially. The server determines the identifiability of the barcode and the identifiability of the individual instance based on the received code value.

Next, referring to FIG. 8, if the identifiability of the barcode is present, but the identifiability of the individual instance is not present, a code value display part 801 in which a barcode type, a manufacturing company, a manufacturing country, a manufacturing date, and a product type are displayed, a serial number error display part 802 in which an error of the serial number of the product is displayed, a serial number generation icon 803, and a registration icon 804 can be displayed.

When the serial number generation icon 803 is executed, the server generates a virtual serial number so that the virtual serial number has an individual instance for the corresponding product and sends the generated virtual serial number. Accordingly, an image, such as that of FIG. 7, is displayed. When the confirm icon 703 and the registration icon 704 are executed, the corresponding product is registered.

A case where both the identifiability of the product code and the identifiability of the individual instance are not present is described below.

Referring to FIG. 6, if an icon for executing product registration is present in the portable device and the icon is executed, the barcode registration region 601, the step-by-step registration region 602, the direct input registration region 603, and the imitation lookup region 604 are displayed.

Here, when the barcode registration region 601 is selected, the barcode is photographed in response to a command to instruct the photographing of the barcode 605 and a code value for the corresponding barcode is transmitted to the server at the same time or sequentially. The server determines the identifiability of the barcode and the identifiability of the individual instance based on the received code value.

Next, referring to FIG. 9, if the identifiability of the barcode and the identifiability of the individual instance are not present, an identification-impossible message 901 informing that the identifiability of the barcode is not present is loaded as in FIG. 9.

After this message is loaded, the user or owner of the portable device can execute a retry icon 902 in order to check whether the barcode can be recognized or not and also execute a manual registration icon 903 in order to perform the step-by-step registration procedure.

When the manual registration icon 903 is executed, an initial registration screen is displayed. When the step-by-step registration region 905 is selected, a screen in which the user or the owner of the portable device can sequentially select pieces of information about the corresponding product from higher-level information to lower-level information is displayed. The user or owner registers the product by selecting the pieces of information that are sequentially presented.

FIG. 9 shows a case where a vehicle product is selected and the manufacturing company of the selected vehicle is selected when a shown information icon 908 is selected. Information about a plurality of vehicle manufacturing companies 909 can be displayed in the screen, and a scroll 910 for scrolling the plurality of vehicle manufacturing companies can be provided.

After the pieces of information about the product are registered step by step through a series of the processes, the server generates a serial number based on the pieces of information or requests the manufacturing company to generate the serial number and receives the generated serial number. The server generates a two-dimensional barcode for the corresponding product based on the generated serial number and completes product registration. Reference numeral 904 not described is a barcode registration region, 906 is a direct input registration region, and 907 is an imitation lookup region (icon).

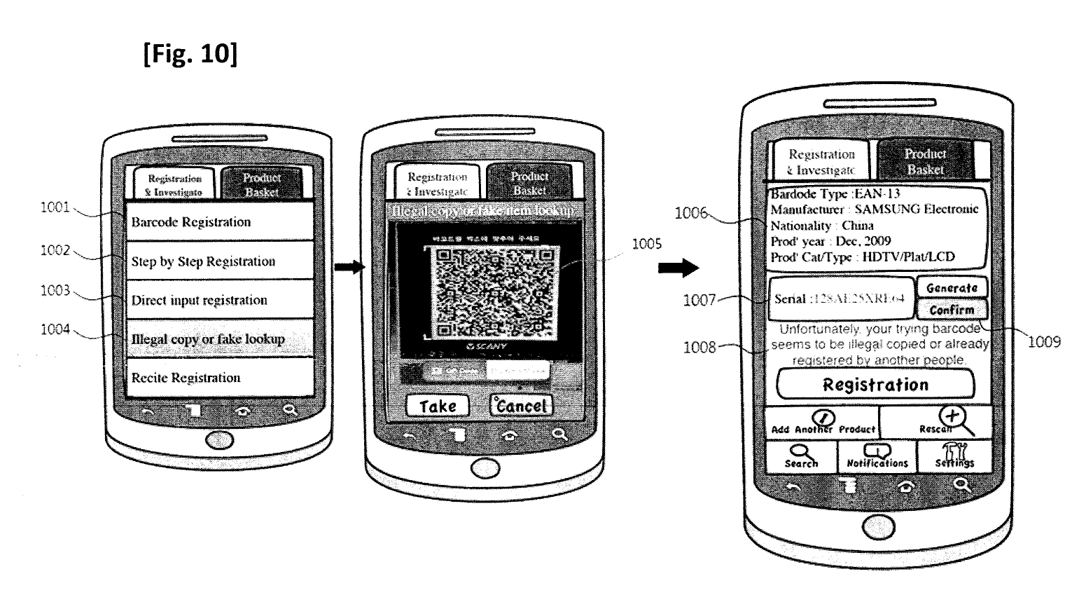

FIG. 10 shows an implementation example for checking whether a product is an honest commodity or not. Whether the product is an imitation commodity or not or a robbed product or not is checked with reference to FIG. 10.

Whether the product is an honest commodity or not is service additionally provided to the registration of the barcode of a product (1001), step-by-step registration (1002) and direct input registration (1003).

Referring to FIG. 10, the owner of a portable device selects whether the product is an honest commodity or not (1004) in order to check whether the product is an honest commodity or not, identifies the corresponding product through a barcode (1005), and sends data to the server (refer to FIG. 10). If a serial number is managed, corresponding information is registered.

If the product is an already registered commodity the registration of the product is informed. A hologram or related information for identifying an imitation assuming that the product is an imitation is downloaded along with an image.

The barcode or whether the product is an honest commodity or not (1004) service is selected, and the barcode or a product name and code are sent to the server.

The server sends corresponding information to a manufacturer/supply company based on the received information or searches a database for checking whether the corresponding product code is a normal distribution code of the product if corresponding inquiry service is requested.

In the case of a normal product, the fact that the corresponding product is an honest commodity is returned. If the product is uncertain, the server can request necessary information from the server of a requesting applicant or the portable device of an owner along with a photograph and test information in order to further check whether the product is an honest commodity or not.

The server automatically generates corresponding information, including related information, in the form of a two-dimensional barcode in real time and downloads the generated information to the server of the requesting applicant or the portable device of the owner. If necessary, the server can generate an image of a product certificate in the form of an image file in real time by automatically inserting requested user information into the image.

The server can guide the information about the corresponding product through a code value display part 1006 related to the corresponding product based on the information, notify the serial number of the corresponding product through a serial number display part 1007, and display that the corresponding product is an already registered product through an imitation lookup display part 1008 so that confirmation and notification can be performed through a confirm icon 1009.

FIG. 11 shows the display screen of a portable device for executing the follow-up management method for a product using a portable device in accordance with the present invention.

When the follow-up product management process is executed, a display window 1101 is displayed in the upper part of the portable device 1100 as shown in FIG. 11.

A registration icon 1110 and a point balance 1105 in which a point value varying by control of a point balance according to the use of the product is displayed are located over the display window 1101.

Product information 1104 related to the product is displayed at the central part of the portable device 1100, and the serial number 1102 of the product is displayed under the display window 1101.

Furthermore, icons related to the follow-up management of the product can be disposed on the right side or the lower part of the portable device 1100. That is, the icons related to the follow-up management can include a used goods transaction icon 1103, a product disuse or contribution icon 1106, a product Buy Care icon 1107, a receipt registration icon 1108, and a product A/S request icon 1109.

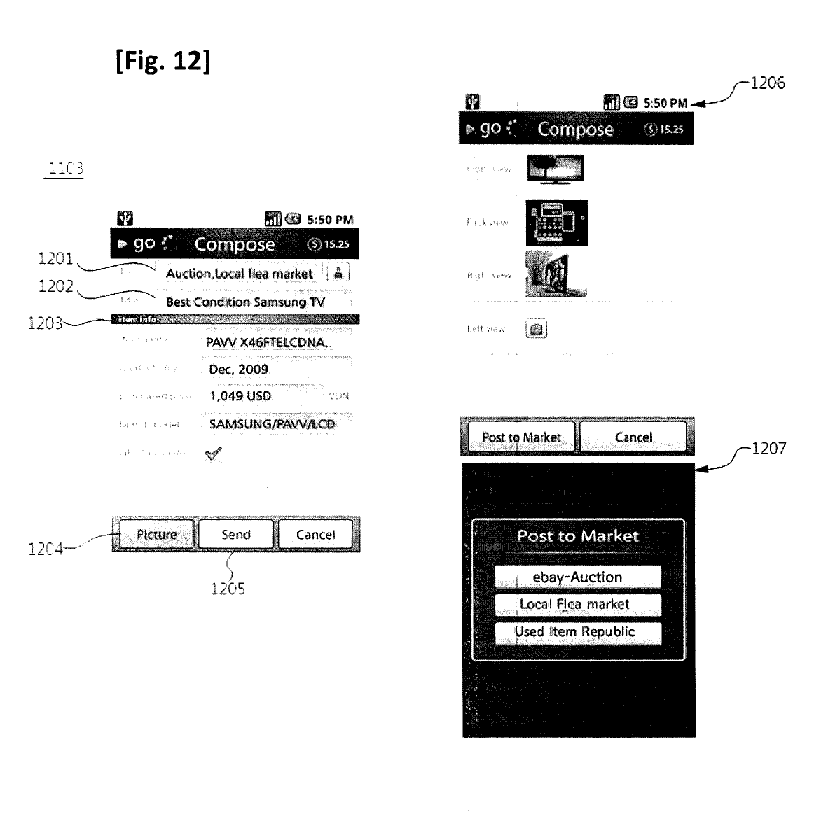

FIG. 12 shows a detailed example of the used goods transaction process for the product registered in the follow-up management method for the product using a portable device in accordance with the present invention.

First, when the used goods transaction icon 1103 shown in FIG. 11 is executed, detailed information about the corresponding product is automatically loaded. Product information 1203 can include the name, manufacturing date, purchase amount, brand name, and model of the product.

A photograph 1206 on the front or rear surface or the left or right side of the product can be loaded along with the product information and then registered with a used goods transaction site by executing a picture icon 1204.

Here, a screen 1207 in which the corresponding used goods transaction site can be selected is provided. The user of the portable device can select E-bay or Auction, that is, the existing used goods transaction site, and select a local flea market related to an area where the portable device is used.

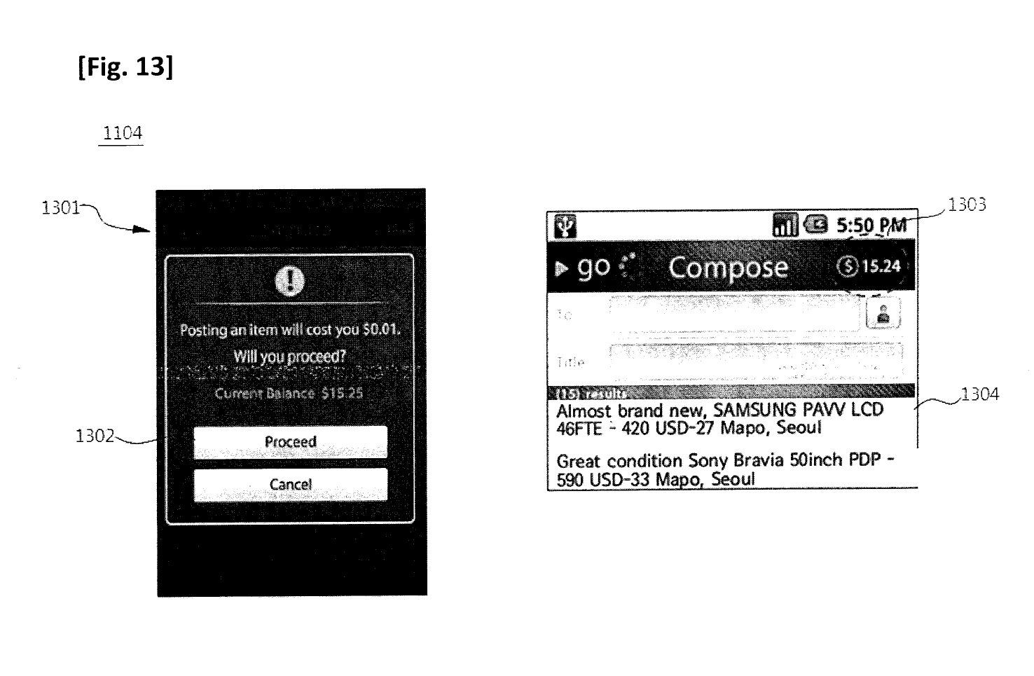

FIG. 13 shows a detailed example of a process of processing a point balance that is generated according to the management of the product registered in the follow-up management method for the product using a portable device in accordance with the present invention.

As shown in FIG. 12, when the corresponding product is registered with the used goods transaction site, a commission according to the registration of the used goods transaction is generated and a screen thereof is provided (1301). When the user clicks on the screen (1302), the corresponding product is registered with the corresponding used goods transaction site (S1304) and a point according to the registration is subtracted. Accordingly, a balance change (1303) from $15.25 to 15.24 obtained by subtracting $0.01 from $15.25 in the current balance of the corresponding product is performed.

A case of the used goods transaction is described as an example, but the case can apply to a case where supplementary service on which other commissions must be paid likewise.

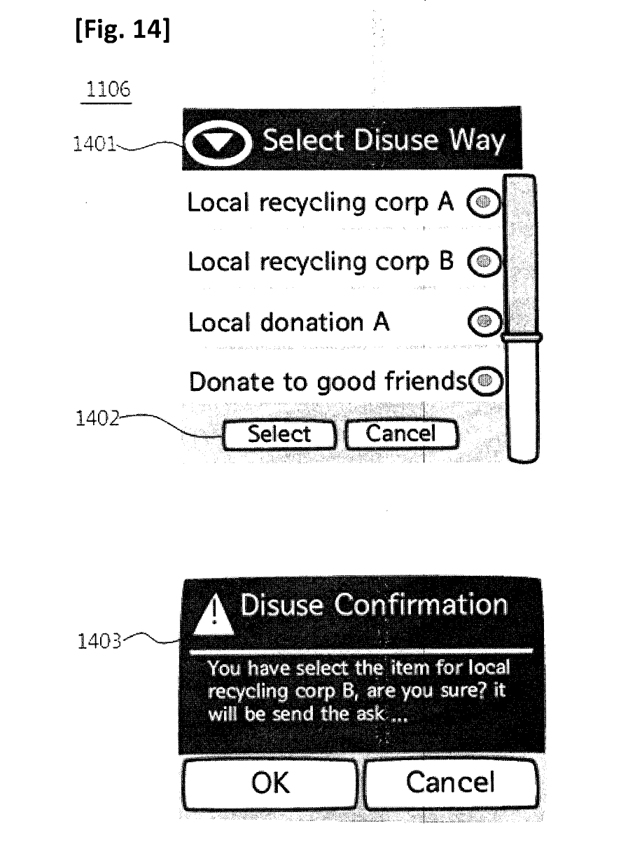

FIG. 14 shows a detailed example of a contribution or donation process for the product registered in the follow-up management method for the product using a portable device in accordance with the present invention.

When a product disuse or contribution icon 1106 shown in FIG. 11 is selected, disuse, contribution, or donation can be selected and executed.

When the product disuse or contribution icon 1106 is selected, a screen, such as that of FIG. 11, is displayed. The user can select (1401) the provided disuse or contribution method by way of a scroll. When the user selects Local recycling corp B, a conform procedure (1403) for checking whether the user will request Local recycling corp B to disuse the corresponding product or not is performed. When the user clicks on Confirm, the disuse or contribution procedure is completed.

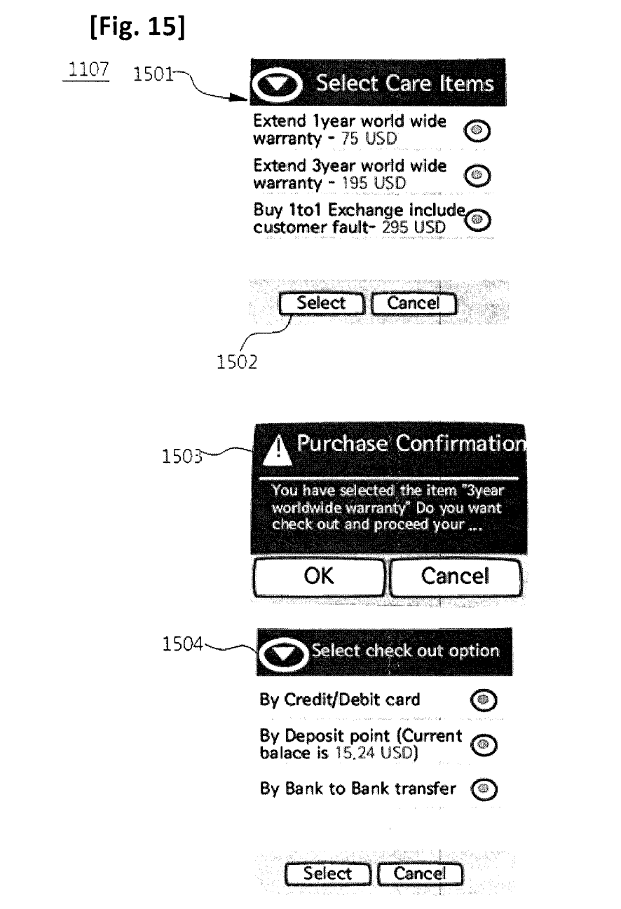

FIG. 15 shows a detailed example of a Buy Care process for the product registered in the follow-up management method for the product using a portable device in accordance with the present invention.

The Buy Care settlement of the product can mean, for example, a transaction method in which a product supply company having confident durability for a product and a consumer who has purchased the corresponding product and used the product for a long time extend protection service for the product when the product supply company and the consumer want to extend protection periods, such as the free repair and free exchange of the product, for each section and pay a commission for the extension.

The Buy Care settlement can also be used in the present invention. When a Buy Care icon 1107 shown in FIG. 11 is clicked on, a screen 1501 in which the care method of the corresponding product can be selected is displayed. A user can select (1502) an extension period and a commission for the extension.

When the user selects an extension period and a commission for the extension (1502), a purchase confirmation procedure screen 1503 is displayed. When the user presses Confirm, a screen 1504 in which a settlement method can be selected is displayed. After the settlement is performed, the Buy Care service procedure is completed.

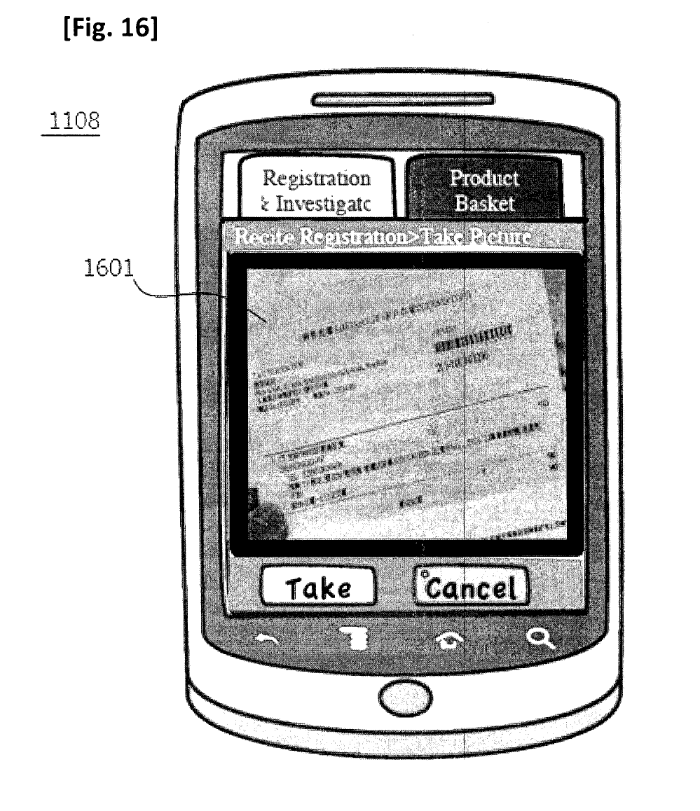

FIG. 16 shows a detailed example of the receipt registration process for the product registered in the follow-up management method for the product using a portable device in accordance with the present invention.

FIG. 16 illustrates an icon receipt registration (Recite Reg. 1108) processing process shown in FIG. 11. If a corresponding product is a specific commodity and if evidence for a purchase receipt is necessary in the regulations of a manufacturing company and a distribution company, the corresponding receipt is photographed by a portable device, stored, and used as evidence data for returns, A/S, and a used goods transaction. Reference numeral 1601 shows an example of a real image of a captured receipt.

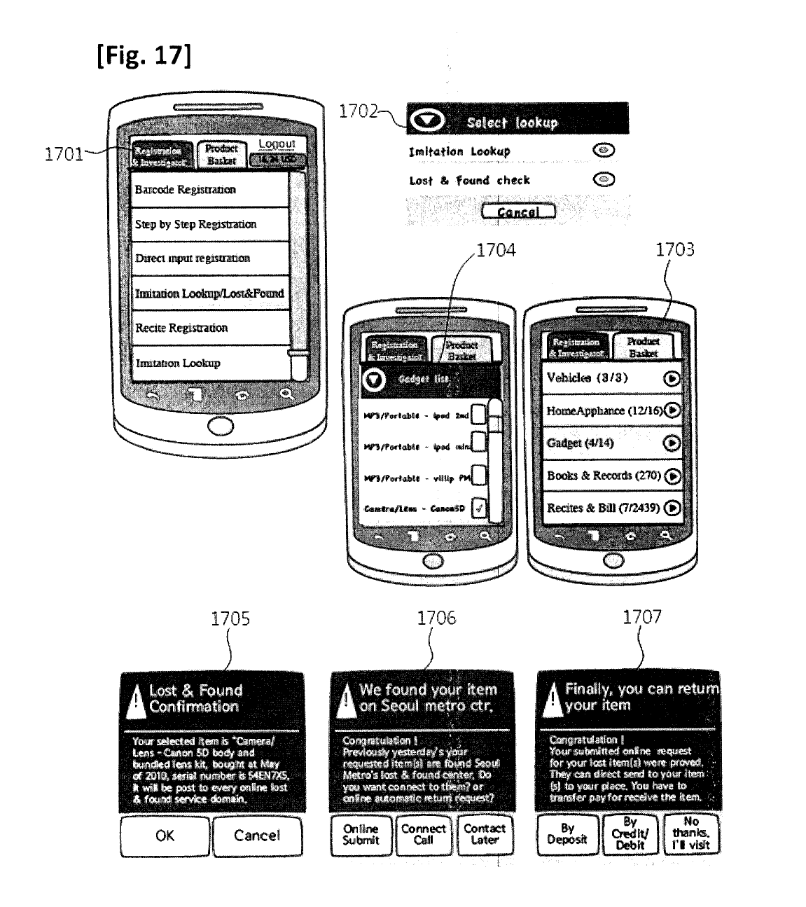

FIG. 17 shows a detailed example of a loss notification and check process when the product registered in the follow-up management method for the product using a portable device in accordance with the present invention is lost.

A screen shown in FIG. 17 corresponds to a screen prior to the screen shown in FIG. 11 and is a screen generated when a registration and examination icon 1701 placed in the upper part of the portable device is clicked on or touched. A lost check icon is displayed in the screen along with the selection of the first product registration method.

Here, when an Imitation Lookup/Lost&Found icon is clicked on, a screen 1702 in which Imitation Lookup and Lost&found check can be selected is presented.

Here, when the Lost&found check is selected, a screen 1703 in which the category of the corresponding product can be selected is displayed. When a Gadget category is selected, a product list screen 1704 corresponding to the Gadget category is loaded. If the lost product is a camera and a manufacturing company is CANON, a user selects the camera and CANON when the product is registered.

In this state, if a loss report product corresponding to the category of the selected product and an item is presented, the management server lists up (1705) the loss report product. This can be performed by automatically processing a loss and robbery report and associating a loss and robbery report with an institute that provides related service. If the list-up (1705) product is matched with the lost product of the user, the user checks and confirms the list-up product by a click and the management server checks the place where the product is kept and loads the place (1706). If the lost product is returned and has been registered as a normal product, the product can be evidenced on-line. Here, the user information registered in the first recognition and registration process for the product can be used to evidence the product. Furthermore, the receipt of the corresponding product stored in a process, such as that of FIG. 16, can be evidenced as evidence data.

If on-line evidence is successful, the user can pay a delivery cost on-line without directly visiting the place, return the lost product through home delivery service, and send a screen 1707 for confirming the return of the lost product.

As described above, in the follow-up management method for a product using a portable device in accordance with the present invention, the product registration to management of the product can be processed in a lump on-line in various ways. A variety of barcodes included in a product are easily photographed by a portable device, and the barcodes are registered and managed. Accordingly, the integrated and general follow-up management method for managing the entire life cycle, including the purchase, use, management, and disuse of the product, as well as A/S of the product on-line by using a portable device can be provided.

Those skilled in the art to which the present invention pertains will understand that the technical construction of the present invention may be implemented in other detailed forms without departing from the technical spirit or essential characteristics of the present invention. Accordingly, the aforementioned embodiments should not be construed as being limitative, but should be construed as being only illustrative from all aspects. The scope of the present invention is defined by the appended claims rather than the detailed description. It should be understood that all modifications or variations derived from the meanings and scope of the present invention and equivalents thereof are included in the scope of the appended claims.

1. A follow-up management method for a product using a portable device, comprising:
a product recognition step, a product registration step, and a product follow-up management step,
wherein the product recognition step comprises:
a code value transmission step of photographing a barcode of the product using the portable device and sending a code value of the barcode to a server; a code value identification step of the server determining whether the received code value of the barcode is identifiable or not; and an individual instance identification step of the server determining whether an individual instance of the product is identifiable after the code value identification step,
in the product registration step, if the instance is identifiable, the portable device executes a registration of the product, and
after the product registration step, in the product follow-up management step, the follow-up management of the product is performed on-line by a user of the portable device.

2. The follow-up management method of claim 1, wherein the product recognition step and the product registration step are classified into cases where the individual instance of the barcode is included or not included, the product is a product databased and registered with the server or a product not databased and registered with the server, and the barcode is identifiable or not identifiable and then processed.

3. The follow-up management method of claim 1, wherein:
the individual instance identification step is divided into a case where the server instructs the portable device to perform step-by-step registration or direct input registration if the code value is not identifiable, and a case where the server determines whether the individual instance of the product is identifiable or not if the code value is identifiable, and
the product registration step further comprises a serial number generation step in which if the instance is not identifiable, the server itself generates a serial number or the server requests a manufacturing company of the product to generate a serial number and executes the registration of the product.

4. The follow-up management method of claim 3, further comprising a two-dimensional barcode generation step in which the server automatically generates a two-dimensional barcode for the product based on the serial number and allows an owner of the portable device to check the two-dimensional barcode, after the serial number generation step.

5. The follow-up management method of claim 3, wherein the step-by-step registration and the direct input registration are a step of sequentially performing the registration of the product by sequentially classifying pieces of information related to the product into higher-level information to lower-level information and presenting the pieces of information.

6. The follow-up management method of claim 3, wherein the server or a manufacturing company generates a two-dimensional code for the corresponding product based on information received according to the step-by-step registration and the direct input registration and sends the two-dimensional code to an owner of the portable device so that the owner can check the two-dimensional code.

7. The follow-up management method of claim 3, wherein the individual instance means an individual value for one individual product included in a plurality of product groups having an identical model.

8. The follow-up management method of claim 3, further comprising a step of an owner of the portable device sending corresponding information to the server and receiving information about whether the product is genuine or not from the server in order to check forgery or robbery for the product.

9. The follow-up management method of claim 1, further comprising a step of an owner of the portable device sending corresponding information to the server and receiving information about whether the product is genuine or not from the server in order to check forgery or robbery for the product.

10. The follow-up management method of claim 1, wherein follow-up management of the product follow-up management step comprises one or more of point management of the product in which a point as much as an amount settled in response to a purchase and processing of the product is increased or decreased and recorded, used goods transaction management of the product in which an on-line used goods transaction of the product is executed, disuse management of the product in which a disuse of the product is requested and checked, A/S management of the product in which A/S for the product is requested and checked, contribution and donation management of the product in which a contribution or donation of the product is requested and checked, and lost article management in which a lost product is checked and returned when the product is lost.

11. The follow-up management method of claim 1, wherein in at any time before or after the product recognition step and the product registration step or before or after the product follow-up management step, a purchase history evidence document processed when the product is purchased is photographed by the portable device and stored.
